(19) United States
(12) Patent Application Publication
(10) Pub. No.: US 2025/0187361 A1
(43) Pub. Date: Jun. 12, 2025

(54) DATA CARRIER WITH MOTIF IMAGES WHICH ARE VISIBLE FROM OPPOSITE FACES, AND CORRESPONDING PRODUCTION METHOD

(71) Applicant: Veridos GmbH, Berlin (DE)

(72) Inventors: Günther ENDRES, München (DE); Klaus KOHL, Miesbach (DE); Tobias ROSATI, Neufahrn (DE)

(21) Appl. No.: 18/846,084

(22) PCT Filed: Mar. 8, 2023
(86) PCT No.: PCT/EP2023/055890

§ 371 Date: Sep. 11, 2024

(30) Foreign Application Priority Data
Mar. 11, 2022 (DE) 10 2022 000 859.9

(51) Int. Cl. B42D 25/351; B42D 25/23

(52) U.S. Cl. CPC B42D 25/351; B42D 25/23

(57) ABSTRACT

The invention relates to a data carrier (10) with two different motif images which are visible from opposite faces of the data carrier, namely a front-side motif (22) and a back-side motif (32). According to the invention, it is provided that the data carrier (10) has a multi-layer structure with an upper motif layer (52), a lower motif layer (62) and an intermediate layer (40) arranged between the motif layers (52, 62) and which is at least partially translucent. It is further provided that a partial motif (22A, 22B) of the front-side motif (22) is arranged in the upper and lower motif layers (52, 62) and the two partial motifs (22A, 22B) complement each other to form the front-side motif (22) when the data carrier is viewed from the front and/or respectively one partial motif (32A, 32B) of the back-side motif (32) is arranged in the upper and lower motif layers (52, 62) and the two partial motifs (32A, 32B) complement each other to form the back-side motif when the data carrier is viewed from the back and that the upper and lower motif layers (52, 62) are each formed by a laser-modified printing ink, the motif information of which, produced by laser exposure and forming the front-side motif (22) and the back-side motif (32), is only visible when viewed in reflected light, but not when viewed in transmitted light.

The invention relates to a data carrier, in particular a value or security document, with two different motif images which are visible from opposite faces of the data carrier, as well as a corresponding production method.

Data carriers such as value or identification documents, but also other valuable items such as branded goods, are frequently provided with security features for security purposes which allow the authenticity of the data carrier to be verified and at the same time serve as protection against unauthorized reproduction. However, with all security features there is a risk of misuse through falsification and/or total counterfeiting of the security feature.

Starting from this, the invention is based on the object of providing a data carrier of the type mentioned initially with a high level of forgery security and an attractive visual appearance.

This object is achieved by the features of the independent claims. Further developments of the invention are the subject of the dependent claims.

The invention provides a data carrier with two different motif images which are visible from opposite faces of the data carrier. For the sake of easier reference and differentiation, the two motif images are referred to as the front-side motif and the back-side motif within the framework of this description. However, this does not imply any restriction, as both motif images can display any information, albeit different.

The data carrier has a multi-layer structure with an upper motif layer, a lower motif layer and an intermediate layer arranged between the motif layers which is at least partially translucent.

It is provided that respectively one partial motif of the front-side motif is arranged in the upper and lower motif layer and the two partial motifs complement each other to form the front-side motif when the data carrier is viewed from the front and/or that respectively one partial motif of the back-side motif is arranged in the upper and lower motif layer and the two partial motifs complement each other to form the back-side motif when the data carrier is viewed from the back. At least one of the two motif images is therefore divided into at least two partial motifs in the said manner, wherein both motif images are accordingly divided into partial motifs in particularly advantageous embodiments.

The front-side motif and the back-side motif are formed by a laser-modified printing ink, the motif information of which is produced by laser exposure and is only visible when viewed in reflected light, but not when viewed in transmitted light. In other words, the front-side motif is only visible when the data carrier is viewed in reflected light from the side of the upper motif layer, and the back-side motif is only visible when the data carrier is viewed in reflected light from the side of the lower motif layer.

The division of at least one motif image into two different levels gives the data carrier a high level of protection against falsification or total counterfeiting since the overall impression of the divided motif image is destroyed by any manipulation of the layer structure. According to the invention, the partial images separated by the intermediate layer and thus located in different levels are produced by laser exposure and therefore fit perfectly together.

Furthermore, by arranging the partial images on different levels, a depth effect can be created that is very difficult to imitate in any other way.

Preferably, it is provided that areas with different reflectivity but substantially unchanged opacity are produced in the laser-modified printing ink by laser exposure, which areas form the said motif information of the front-side motif and the back-side motif. In particular, the reflectivity in the laser-exposed areas of the printing ink can be increased so that these areas appear brighter in incident light than the non-exposed areas.

In an advantageous embodiment, it is provided that
the laser-modified printing ink is formed by laser exposure of a laser-modifiable printing ink, namely a printing ink provided with platelet-shaped, multi-layer interference pigments, in which an outer layer of the interference pigments is alterable by laser exposure, and
an outer layer of the interference pigments in the areas with motif information of the front-side motif and/or the back-side motif is altered by the laser exposure, in particular is made transparent.

The platelet-shaped, multilayer interference pigments of the printing ink are preferably aligned substantially parallel to the layer surface in the upper and lower motif layers.

The said interference pigments advantageously comprise a middle reflection layer, two dielectric layers surrounding the middle reflection layer and two outer, partially transparent layers. In the areas with motif information of the front-side motif and/or the back-side motif, one or both outer layers of the interference pigments are advantageously modified by the laser exposure, in particular made transparent, whereas the middle reflection layer remains unaltered.

The layer structure of the unmodified interference pigments is preferably symmetrical, i.e. the materials and layer thicknesses of the dielectric layers and the partially transparent layers are the same on both sides of the reflection layer.

The middle reflection layer is preferably a metal layer, for example made of aluminium or silver, in particular an opaque metal layer. The transmission of the outer, partially transparent layers in the unmodified state is advantageously between 30% and 65%, and in the state modified by laser exposure it is preferably below 30%, in particular below 10%. The outer, partially transparent layers can consist of chromium.

The unmodified interference pigments advantageously display a colour shift effect or a fixed colour. As a result of the change in the outer layer of the interference pigments, the colour shift effect or the fixed colour changes, so that the area exposed to the laser appears in reflection with a changed colour impression. For example, the outer layer can be made largely or completely transparent by the laser exposure, so that the bright reflection of the middle reflection layer dominates there and as a result, a brighter colour impression than that due to the colour shift effect or the fixed colour is produced. Since the middle reflection layer remains unchanged during the laser exposure, the opacity of the interference pigments and thus also of the printing ink practically does not change.

It is advantageous if the upper and lower motif layers are formed using the same laser-modified printing ink. The unmodified areas of both motif layers therefore appear with the same colour impression.

The upper and lower motif layers are preferably offset from one another, in particular the upper and lower motif layers are configured to overlap one another in projection or to abut one another directly in projection. In a further advantageous embodiment, the upper motif layer is arranged completely within, but not congruent with, the lower motif layer in projection. Conversely, the lower motif layer can also be arranged completely within, but not congruent with, the upper motif layer in projection. In the context of this description, projection means a projection perpendicular to the layer plane of the motif layers or of the entire data carrier.

Advantageously, the upper and lower motif layers are configured to be opaque.

In an advantageous embodiment, the intermediate layer is configured to be transparent in the area of the motif images, in particular it is provided that the intermediate layer is formed by an opaque core layer, which is equipped with a transparent insert in the area of the motif images. The opaque core layer can also be composed of several partial layers. The intermediate layer advantageously has a thickness of more than 100 μm, in particular a thickness of between 100 μm and 500 μm. The optical properties of the insert can be additionally modified to achieve further effects.

Preferably, the upper and lower motif layers are each covered with a transparent cover film. In particular, the upper and lower motif layers are printed on the respective covering cover film. Another advantage of this is that there is a large area available for each motif image. Even if the laser-modifiable printing inks used for the motif layers have a relatively low bond to the adjacent cover layers, so that the area of each motif layer that can be achieved in practice is limited, the available area can be doubled for each image by dividing the image motifs into two levels.

In addition, the division, particularly when using dot and/or line grids, has the advantageous side effect of reducing the printed area in relation to the unprinted area, so that the laser behaviour of the motif layers is improved during subsequent laser exposure and, in particular, so-called bursts can be reduced or completely avoided.

The motif information of at least one of the motif images advantageously contains a personalization, in particular a portrait and/or a signature.

The data carrier represents in particular a value or security document and is advantageously an identification card, in particular an identity card, a data page for an identity document, a bank card, a credit card or a driving licence.

The invention also includes a method for producing a data carrier of the type mentioned, in which
the data carrier is formed with a multi-layer structure with an upper motif layer, a lower motif layer and an intermediate layer arranged between the motif layers which is at least partially translucent,
respectively one partial motif of the front-side motif is arranged in the upper and lower motif layer and the two partial motifs complement each other to form the front-side motif when the data carrier is viewed from the front and/or
respectively one partial motif of the back-side motif is arranged in the upper and lower motif layers and the two partial motifs complement each other to form the back-side motif when the data carrier is viewed from the back, and
the upper and lower motif layers are each formed by a laser-modified printing ink in which, by laser exposure, motif information forming the front-side and backside motifs is produced which is only visible when viewed in reflected light, but not when viewed in transmitted light.

In an advantageous procedure, it is provided that a laser-modifiable printing ink is arranged on opposite sides of the intermediate layer to produce the motif images, and the motif information of the front-side motif is produced by laser exposure from the side of the upper motif layer and the motif information of the back-side motif is produced in the upper and/or lower motif layer by laser exposure from the side of the lower motif layer.

In particular, the motif information of the partial images of the front-side motif and/or the back-side motif separated by the intermediate layer is produced in the same operation by laser exposure. The partial images are therefore perfectly aligned with each other.

Advantageously, it is provided in the method that the laser-modifiable printing ink of the upper and lower motif layers is in each case printed onto a transparent cover film, the printed cover films are connected to the intermediate layer, and the laser-modifiable printing ink is subsequently exposed to laser radiation in order to produce the motif information of the front-side motif and the back-side motif in the upper and/or lower motif layer.

Further embodiments and advantages of the invention are explained hereinafter with reference to the figures, in which a true-to-scale and true-to-proportion reproduction was dispensed with in order to increase clarity.

In the figures:

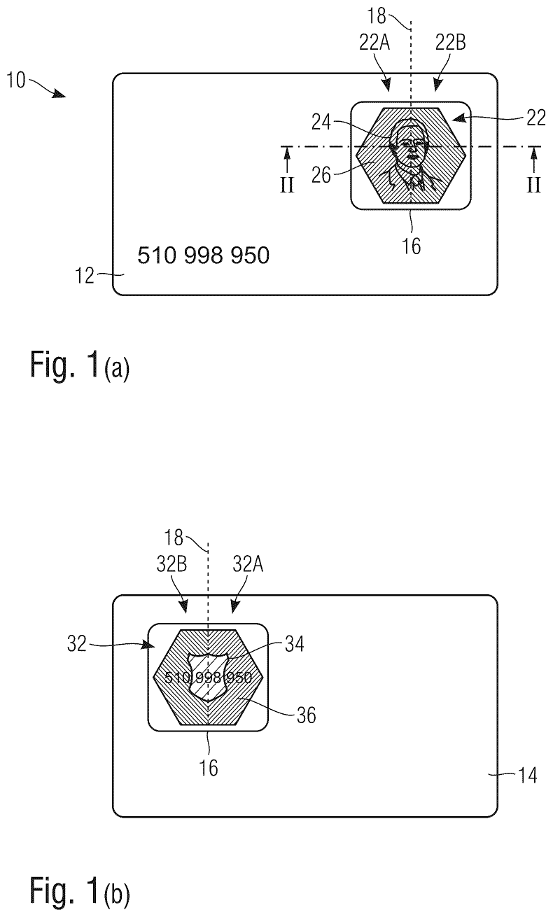

FIG. 1 shows schematically an identification card according to the invention, wherein (a) the appearance of the card when viewed from the front side and (b) the appearance when viewed from the back side are shown,

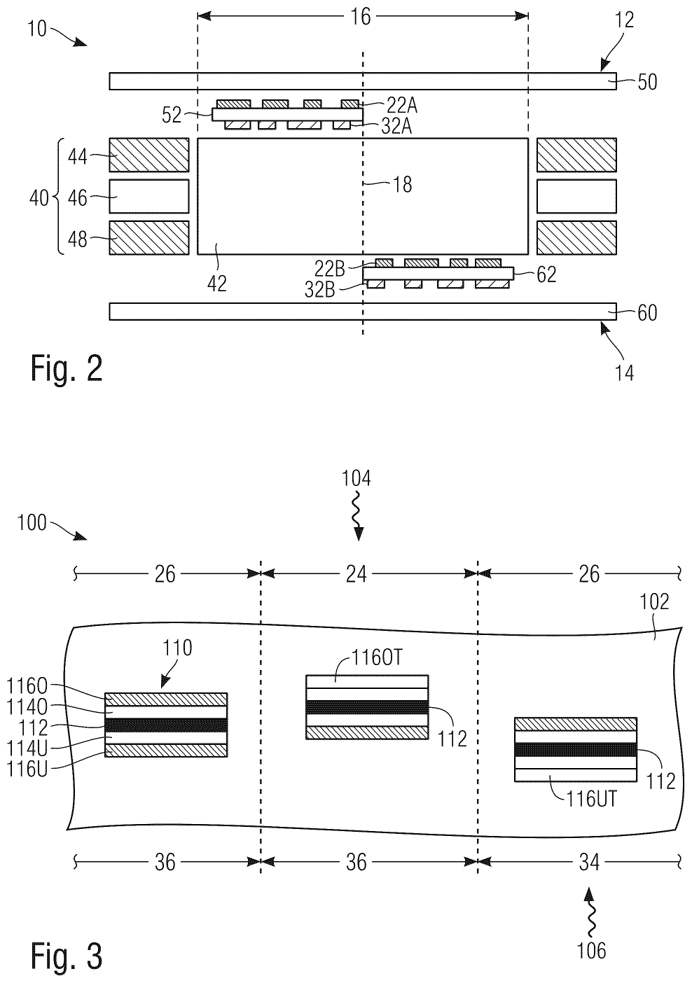

FIG. 2 shows schematically the layer structure of the identification card in the window area along the line II-II of FIG. 1,

FIG. 3 shows schematically a laser-modifiable and partially already laser-modified printing ink for use for the motif layers of the identification card of FIGS. 1 and 2,

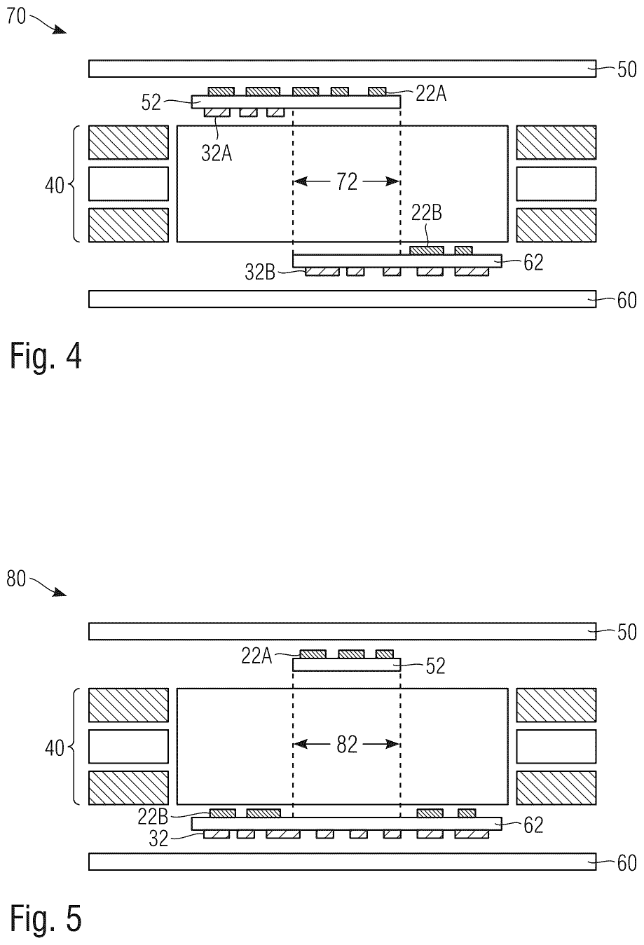

FIG. 4 shows an identification card according to another embodiment of the invention with overlapping motif layers, and

FIG. 5 shows an identification card according to a further embodiment of the invention, in which the upper motif layer is arranged completely within, but not congruent with, the lower motif layer.

The invention will now be explained using the example of identification cards.

FIG. 1 shows a schematic representation of an identification card 10, such as an ID card, bank card, credit card or driving licence, wherein FIG. 1(a) shows the appearance of the card when viewed from the front side 12 of the card and FIG. 1(b) shows the appearance when viewed from the back side 14 of the card.

A window area 16 is formed in the identification card 10, in which different motif images 22, 32 are visible when viewed from the front side (FIG. 1(a)) and the back side (FIG. 1(b)). In the exemplary embodiment, the front-side motif 22 represents a passport photo 24 of the holder of the card 10, which is visible against a single-coloured background 26. For example, the passport photo 24 in black and white appears silvery light against a relatively dark, blue background in hexagonal shape 26.

The back-side motif 32 is a graphic motif 34, for example a national emblem combined with a reproduction of the card number, which is visible against a single-coloured background 36. In the exemplary embodiment, the graphic motif 34 also appears silvery light against a hexagonal blue background 36.

Whereas the background 26, 36 of the two motifs is configured to be congruent in the shape of a hexagon and is visible from both sides with the same blue colour, the front-side motif 22 with the passport photo 24 is only visible when viewed from the front side and the back-side motif 32 with the graphic motif 34 is only visible when viewed from the back side. The front- and back-side motifs are not visible from the opposite side and therefore do not influence or interfere with each other.

As a further special feature, each of the two motif images 22, 32 consists of two partial motifs 22A, 22B or 32A, 32B, which are arranged at different height levels inside the card 10 in a manner that is recognizable to the viewer and together form the complete motif image 22 or 32.

The point at which the partial motifs meet is indicated in FIGS. 1(a) and 1(b) by a dashed line 18. This dashed line is only for illustrative purposes and is not part of the motif images. The motif images 22, 32 show a depth effect in which the viewer, for example when moving, in particular when tilting the card 10, can see due to a small mutual shift of the partial motifs that the partial motifs are not arranged in the same plane but at two different height levels.

The structure and the creation of the described appearances of the identification card 10 when viewed from the front and back sides are now explained in more detail with reference to FIG. 2, which schematically shows the layer structure of the identification card 10 in the window area along the line II-II of FIG. 1. For the sake of a clearer representation, the various elements of the card are shown in an exploded view. In the figure, the front side 12 of the card is shown at the top, the back side 14 at the bottom.

The identification card 10 comprises a central core layer 40, which is equipped with a transparent insert 42 in the window area 16. The core layer 40 itself can consist of several partial layers, for example a first, opaque core film 44, a second, transparent or opaque core film 46 and a third, opaque core film 48. The shape and size of the transparent insert 42 define the shape and size of the window area 16 of FIG. 1.

The middle core layer 40 is covered on both the front side and also on the back side with a transparent cover film 50 or 60. In the window area 16, an upper motif layer 52 is provided between the middle core layer 40 and the upper cover film 50 and a lower motif layer 62 made of a laser-modified printing ink is provided between the core layer 40 and the lower cover film 60.

The said printing ink has the special property that the printed motif layers in the unmodified state of the printing ink can be locally modified by laser exposure from both the front side and from the back side of the card in such a manner that their appearance in incident light, i.e. from the respective side of exposure, becomes brighter, but their opacity in transmitted light remains unchanged.

For a more detailed explanation, FIG. 3 schematically shows a specific example of such a laser-modifiable or partially laser-modified printing ink 100. In the printing ink 100, a plurality of platelet-shaped interference pigments 110 are embedded in a binder 102, which align themselves substantially parallel to the carrier surface when the printing ink 100 is printed onto a carrier.

The platelet-shaped interference pigments 110 have a five-layer structure and consist of a middle reflection layer 112, two dielectric layers 114O, 114U surrounding the middle reflection layer 112 and two outer, partially transparent layers 116O, 116U. The layers are coordinated with one another in such a way that the interference pigments show a colour shift effect from both sides, for example from magenta to green or from gold to green. Depending on the choice of materials and layer thicknesses, other colour shift effects or other colour impressions can also be created. In the present case, a symmetrical layer structure with the same dielectric layers 114O, 114U and the same partially transparent layers 116O, 116U is taken as the starting point so that the same colour shift effect is visible on both sides. The top/bottom orientation of the pigments 110 in the printing ink 100 then plays no role.

By means of a suitable laser exposure of the printing ink 100, it can now be achieved that only the partially transparent layers 116O or 116U of the interference pigments 110 facing the direction of exposure are affected. In particular, it has been found that the light transmittance of the partially transparent layer of a pigment can be increased by laser exposure to such an extent that the colour shift effect on the exposure side disappears almost completely. In incident light, the viewer then sees the lighter reflection colour of the middle reflection layer 112 instead of the relatively darker interference colour of the pigment, which typically creates a silvery, shiny colour impression.

The modification is not visible from the opposite side of the pigment, since the colour impression there is determined by the layer sequence of reflection layer, dielectric layer and unchanged partially transparent layer. The opacity of the interference pigments 110 is also substantially determined by the opacity of the unchanged reflection layer 112, so that the opacity of the interference pigments is also not changed by the laser exposure.

In FIG. 3, the left part of the figure shows an area of a motif layer 52 or 62 produced with the printing ink 100, in which no laser modification of the interference pigments 110 has taken place. In the exemplary embodiment, the layers of pigments 110 are coordinated with one another in such a way that a blue colour impression can be perceived from both sides when viewed vertically in incident light. This corresponds to the situation in an area of the motif layers 52, 62 in which the dark, blue background 26 or 36 is visible from both sides.

The middle part of FIG. 3 shows an area of the motif layer 52 or 62 in which the interference pigments 110 were modified by laser exposure 104 only from the front side. As described, the upper partially transparent layer 116OT becomes almost completely transparent due to the laser exposure, so that the bright reflection colour of the reflection layer 112 dominates. The modified area therefore has a bright, silvery colour impression when viewed from the front. This corresponds to the situation in an area of the motif layers 52, 62 in which a bright part of the passport photo 24 is visible on the front side and the dark, blue background 36 is visible on the back.

Finally, the right part of FIG. 3 shows an area of the motif layer 52 or 62 in which the interference pigments 110 have been modified by laser exposure 106 from the back side. In this case, the lower partially transparent layer 116UT becomes almost completely transparent due to the laser exposure, so that a light, silvery colour impression is created when viewed from the back side. This corresponds to the situation in an area of the motif layers 52, 62 in which a light part of the graphic motif 34 is visible on the back side and the dark, blue background 26 is visible on the front side.

It is understood that there can also be areas of the motif layer 52 or 62 in which the interference pigments 110 have been modified by laser exposure 104, 106 from both sides. In this case, both the upper and also the lower partially transparent layers are almost completely transparent, so that a light, silvery colour impression is visible on both sides. This corresponds to the situation in an area of the motif layers 52, 62 in which a light part of the passport photo 24 is visible on the front side and a light part of the graphic motif 34 is visible on the back side.

Returning to the illustration in FIG. 2, the motif layers 52, 62 formed by the printing ink 100 are not congruent, but are arranged offset from one another. In the exemplary embodiment of FIG. 2, the motif layers 52, 62 are specifically arranged in such a manner that they directly abut one another in projection.

During personalization, the card 10 was exposed to laser radiation vertically from the front side 12 in the window area 16, and thereby both the upper motif layer 52 and the lower motif layer 62 are locally modified and the front-side motif 22 was thereby produced. The simultaneous modification of the two motif layers 52, 62 is possible since both the upper cover layer 50 and the insert 12 are configured to be transparent to the modifying laser radiation and the motif layers 52, 62 are arranged next to one another from the front-side exposure direction. During the laser exposure, a first partial motif 22A is therefore created in the upper motif layer 52 and a second partial motif 22B is created in the lower motif layer 62 from the front-side motif 22.

When viewed vertically from the front side, the partial motifs 22A, 22B complement each other in precise registration to form the overall motif 22. Depending on the thickness of the middle core layer 40, the viewer can perceive, with a slight movement or tilting of the card 10, that the two partial motifs 22A, 22B are moving against each other and are therefore arranged at different height levels inside the card 10. With relatively large layer thicknesses of the middle core layer 40, for example up to 500 μm, this shift of the partial motifs can be very clearly perceptible. With small layer thicknesses and/or with a suitable design of the motif images, the relative shift can also be barely perceptible or hidden for the viewer. In the former case, the depth effect serves as an additional, characteristic and visually verifiable authenticity feature, whereas in the latter case the additional security due to the arrangement of the motif images at different levels represents a hidden authenticity feature.

As described in connection with FIG. 3, the modification of the motif layers 52, 62 introduced from the front side is only visible when viewed from the front side 12, but not when viewed from the back side 14.

Similarly to the production of the front-side motif, the card 10 was exposed to laser radiation vertically from the back side 14 during personalization in the window area 16. Both the upper motif layer 52 and the lower motif layer 62 were locally modified, thereby producing the back-side motif 24. The simultaneous modification of the motif layers 52, 62 is possible since both the lower cover layer 60 and the insert 12 are configured to be transparent to the modifying laser radiation and the motif layers 52, 62 are arranged next to one another from the back-side exposure direction. A first partial motif 32A is therefore produced from the back-side motif 32 in the upper motif layer 52 and a second partial motif 32B in the lower motif layer 62.

As when viewed from the front side, when viewed vertically from the back side, the partial motifs 32A, 32B complement each other in precise registration to form the overall motif 32 and the viewer can see by moving or tilting the card 10 that the partial motifs 32A, 32B are arranged at different height levels inside the card 10. The modification of the motif layers 52, 62 introduced from the back side is not recognizable when viewed from the front side 12.

The identification card 10 has an excellent level of protection against counterfeiting, since if one of the cover layers 50, 60 with the printed motif layers 52, 62 is removed manipulatively, the two partial motifs of the motif images 22, 32 are separated from one another and their overall impression is therefore destroyed. As a result, any manipulation of the layer structure, for example by milling off the information on the back side of the card, is immediately recognizable on the front side as well. In addition, due to the simultaneous laser personalization of the motif layers 52, 62 on two levels and in one step it is no longer possible to repair the destroyed motif images.

FIG. 4 shows an identification card 70 according to a further exemplary embodiment of the invention. The structure of the identification card 70 largely corresponds to the structure of the card 10 in FIG. 2, but differs in the configuration of the motif layers 52, 62. The upper motif layer 52 and the lower motif layer 62 are arranged offset from one another in the exemplary embodiment of FIG. 4 such that the upper and lower motif layers 52, 62 overlap one another in projection.

In the overlapping area 72, the upper motif layer 52 is substantially only visible when viewed from the front side and the lower motif layer 62 is substantially only visible when viewed from the back side. The overlapping ensures that when the data carrier is viewed obliquely, no transparent gap can be seen between the respective partial images of the motif images 22, 32, but that the dark background 26, 36 appears continuous from both viewing directions.

In the further exemplary embodiment of FIG. 5, the structure of the identification card 80 also largely corresponds to the structure of the card 10 of FIG. 2 and differs only in the configuration of the motif layers 52, 62.

In the exemplary embodiment of FIG. 5, the upper motif layer 52 is provided in an area 82 which, in projection, is arranged completely within, but not congruent with, the lower motif layer 62. In this configuration, only the front-side motif 22 consists of two partial motifs 22A, 22B at different height levels, whereas the back-side motif 32 is only formed at a single height level, namely in the lower motif layer. The protective effect described is also realized in this exemplary embodiment, since the front-side motif 22 is destroyed by removal of the back-side information of the card 80.

### REFERENCE LIST

10 Identification card
12 Card front side
14 Card back side
16 Window area
18 Dividing line partial motifs
22 Front-side motif
22A, 22B Partial motifs
24 Passport photo
26 Background
32 Back-side motif
32A, 32B Partial motifs
34 Graphic motif
36 Background
40 Core layer
42 Transparent insert
44 Opaque core film
46 Transparent or opaque core film
48 Opaque core film
50 Transparent cover film
52 Upper motif layer
60 Transparent cover film
62 Lower motif layer
100 Printing ink
102 Binder
104, 106 Laser exposure
110 Interference pigments
112 Middle reflection layer
114O, 114U Upper or lower dielectric layer
116O, 116U Upper or lower partially transparent layer
116OT Transparent upper outer layer
116UT Transparent lower outer layer

1. A data carrier, in particular a valuable or security document, with two different motif images which are visible from opposite faces of the data carrier, namely a front-side motif and a back-side motif, wherein
the data carrier has a multi-layer structure with an upper motif layer, a lower motif layer and an intermediate layer arranged between the motif layers which is at least partially translucent,
respectively one partial motif of the front-side motif is arranged in the upper and lower motif layers and the two partial motifs complement each other to form the front-side motif when the data carrier is viewed from the front side and/or
respectively one partial motif of the back-side motif is arranged in the upper and lower motif layer and the two partial motifs complement each other to form the back-side motif when the data carrier is viewed from the back side, and
the upper and lower motif layers are each formed by a laser-modified printing ink, the motif information of which, produced by laser exposure and forming the front-side and back-side motifs, is only visible when viewed in reflected light, but not when viewed in transmitted light.

2. The data carrier according to claim 1, characterized in that in the laser-modified printing ink, areas with different reflectivity but substantially unchanged opacity are produced by laser exposure, which form the said motif information of the front-side motif and the back-side motif.

3. The data carrier according to claim 1 or 2, characterized in that
the laser-modified printing ink is formed by laser exposure of a laser-modifiable printing ink, namely a printing ink provided with platelet-shaped, multi-layer interference pigments, in which by laser exposure an outer layer of the interference pigments is alterable, and
an outer layer of the interference pigments in the areas with motif information of the front-side motif and/or the back-side motif is altered by the laser exposure, in particular is made transparent.

4. The data carrier according to claim 3, characterized in that the interference pigments comprise a middle reflection layer, two dielectric layers surrounding the middle reflection layer and two outer, partially transparent layers.

5. The data carrier according to claim 4, characterized in that in the areas with motif information of the front-side motif and/or the back-side motif, one or both outer layers of the interference pigments is changed by the laser exposure, in particular are made transparent, whereas the middle reflection layer is unaltered.

6. The data carrier according to at least one of claims 1 to 5, characterized in that the upper and lower motif layers are formed by the same laser-modified printing ink.

7. The data carrier according to at least one of claims 1 to 6, characterized in that the upper and lower motif layers are offset from one another, in particular that the upper and lower motif layers are configured to overlap one another in projection or to directly abut one another in projection.

8. The data carrier according to at least one of claims 1 to 7, characterized in that the upper and lower motif layers are configured to be opaque.

9. The data carrier according to at least one of claims 1 to 8, characterized in that the intermediate layer is configured to be transparent in the region of the motif images, in particular that the intermediate layer is formed by an opaque core layer which is equipped with a transparent insert in the region of the motif images.

10. The data carrier according to at least one of claims 1 to 9, characterized in that the intermediate layer has a thickness above 100 μm, in particular a thickness between 100 μm and 500 μm.

11. The data carrier according to at least one of claims 1 to 10, characterized in that the upper and lower motif layers are each covered with a transparent cover film.

12. The data carrier according to at least one of claims 1 to 11, characterized in that the motif information of at least one of the motif images contains a personalization, in particular a portrait and/or a signature.

13. The data carrier according to at least one of claims 1 to 12, characterized in that the data carrier is an identification card, in particular an identity card, a data page for an identity document, a bank card, a credit card or a driving licence.

14. A method for producing a data carrier according to one of claims 1 to 13, in which
the data carrier is formed with a multi-layer structure with an upper motif layer, a lower motif layer and an intermediate layer arranged between the motif layers which is at least partially translucent,
respectively one partial motif of the front-side motif is arranged in the upper and lower motif layer and the two partial motifs complement each other to form the front-side motif when the data carrier is viewed from the front side, and/or
respectively one partial motif of the back-side motif is arranged in the upper and lower motif layers and the two partial motifs complement each other to form the back-side motif when the data carrier is viewed from the back, and
the upper and lower motif layers are each formed by a laser-modified printing ink in which, by laser exposure, motif information forming the front-side and back-side motifs is produced and which is only visible when viewed in reflected light, but not when viewed in transmitted light.

15. The method according to claim 14, characterized in that, in order to produce the motif images, a laser-modifiable printing ink is arranged on opposite faces of the intermediate layer, and the motif information of the front-side motif is produced by laser exposure from the side of the upper motif layer, and the motif information of the back-side motif is produced by laser exposure from the side of the lower motif layer in the upper and/or lower motif layer.

16. The method according to claim 14 or 15, characterized in that the laser-modifiable printing ink of the upper and lower motif layers is printed onto a transparent cover film, the printed cover films are bonded to the intermediate layer, and the laser-modifiable printing ink is subsequently exposed to laser radiation in order to produce the motif information of the front-side motif and the back-side motif in the upper and/or lower motif layer.
